(19) United States
(12) Patent Application Publication
(10) Pub. No.: US 2004/0046996 A1
(43) Pub. Date: Mar. 11, 2004

(54) Image processing multifunction system, server, and scanner

(76) Inventor: Hong Sun, Chiba (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/659,304

(22) Filed: Sep. 11, 2003

(30) Foreign Application Priority Data
Sep. 11, 2002 (JP) 2002-265812

(51) Int. Cl. B41F 1/00; G06F 15/00; H04N 1/00

(52) U.S. Cl. 358/1.15; 358/401

(57) ABSTRACT

Plural printers, one scanner, and a server are connected to each other via a network. The scanner is not connected with a personal computer. The scanner reads image data from a document. The server sends the image data read by the scanner to any one of the printers.

### BACKGROUND OF THE INVENTION

1) Field of the Invention

The present invention relates to an image processing multifunction system, a server, and a scanner.

2) Description of the Related Art

Recently, network technologies, such as a local area network (LAN) achieved a remarkable advance in an office environment and the like with rapid improvement and spread of a personal computer.

A typical example of a LAN system is a network printing system in which a plurality of PCs and a plurality of printers of different types are connected as peripheral equipments with the LAN such as Ethernet (registered trademark). The network printing system utilizes a distributed process of printing data from a plurality of users to improve a printing efficiency by supplying printing image data from an arbitrary personal computer to a desired printer. In this case, possible system configurations include a server/client system in which a specific personal computer is used as a server and other personal computers are used as clients, and a peer-to-peer system in which individual personal computers are equivalently connected. Furthermore, in another system, a personal computer to which a scanner is connected is used, image data read by the scanner is captured and stored in the personal computer, and the image data are supplied to a desired printer.

On the other hand, in recent years, in addition to printers and copying machines having a simple printing function and a simple copying function, respectively, a multiple function product (MFP) having copying, printing, scanning and facsimile functions are developed and remarkably spread as an image processing equipment based on digitalization of copying machines. As a result, the above LAN systems provide suggested examples and embodiments that have a plurality of MFPs with LAN boards instead of a plurality of printers.

According to the system construction with the MFPs connected with the LAN, a wider selection of application can be expected as compared with the conventional system construction where a plurality of printers is connected.

When the function of the MFPs connected with LAN is considered in offices and the like, although a frequency in use of the printing function is high, frequencies in use of the copying and scanner functions are low in most cases. For this reason, it is not efficient to equip an individual MFP with the full functions. Instead, a necessary number of the printers are more desired. In such a case, however, if MFPs are replaced with the conventional printers simply because the frequencies in use of the copying and scanner functions are low, the copying and scanning functions cannot be used at all.

As an MFP to connect to a LAN, a printer with a built in scanner is also available. On a system with such a printer, however, only printers to which scanners are built in serves as MFPs, and the copying function is available only with such printers. As a result, while a printer having the copying function carries out the printing function, for example, the copying function cannot be used, or the printing operation is interrupted if the copying operation is given a priority. This construction is inefficient and is not preferable on the system construction for a distributed process.

When a personal computer to which a scanner is connected is used, a document image is read by the scanner and output to a desired printer. This copying function is practically a printing function that prints out the image data obtained by the personal computer using the printer and involves the operation of the personal computer. For this reason, this copying function is a far from that of the copying machine which can immediately obtain a copy with a simple operation.

### SUMMARY OF THE INVENTION

It is an object of the present invention to solve at least the problems in the conventional technology.

The image processing multifunction system according to one aspect of the present invention includes a plurality of printers, a plurality of scanners, and a server connected to each other, wherein each of the scanners acquires image data of a document and the server sends the image data acquired by the scanner to one of the printers for printing.

The server according to another aspect of the present invention includes a first interface to which a plurality of printers and a plurality of scanners are connected, wherein each of the scanners acquires image data of a document, and a second interface to which a network is connected, wherein the server sends the image data acquired by the scanner to one of the printers for printing.

The scanner according to still another aspect of the present invention includes an interface that is connected to a server, wherein the server is connected with a network and a plurality of printers, manages and controls the printers, a scanner engine, and an operation unit, wherein when in a copying mode, the scanner reads image data from a document via the scanner engine by operating the operation unit alone, and supplies the image data to one of the printers via the server.

The other objects, features and advantages of the present invention are specifically set forth in or will become apparent from the following detailed descriptions of the invention when read in conjunction with the accompanying drawings.

### BRIEF DESCRIPTION OF THE DRAWINGS

FIG. 1 is a schematic diagram of an image processing multifunction system according to one embodiment of the present invention;

FIG. 2 is a schematic diagram of an example of a server;

FIG. 3 is a schematic diagram of an example of an engine;

FIG. 4 is a schematic diagram of an example of a printer;

FIG. 5 is a flowchart of an example of a printer selecting process;

FIG. 6 is a flowchart of another example of the printer selecting process;

FIG. 7 is a block diagram of a modified example of a system configuration; and

FIG. 8 is a block diagram of another modified example of the system configuration.

### DETAILED DESCRIPTION

Exemplary embodiments of an image processing multifunction system, a server, and a scanner of the present invention are explained in detail with reference to the accompanying drawings.

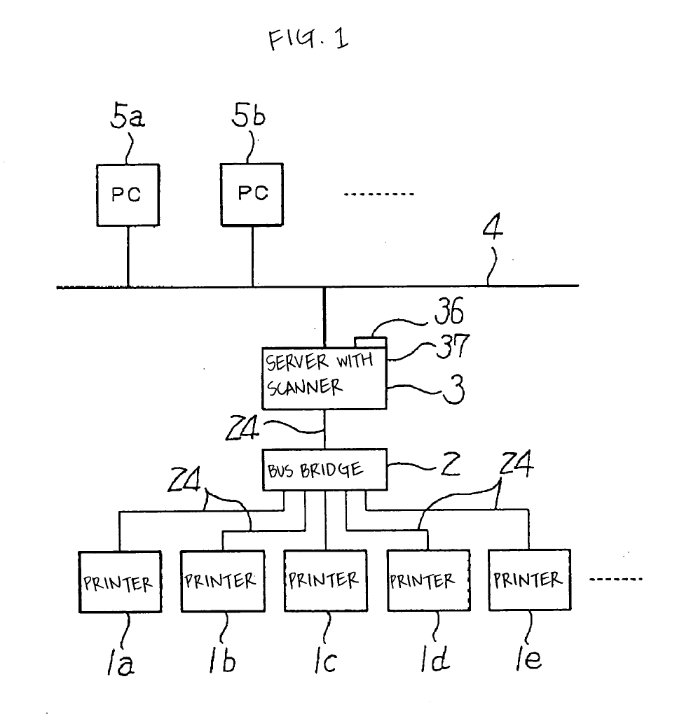

FIG. 1 is a schematic diagram of an image processing multifunction system according to one example of the present invention. The system is provided with a server 3 which is connected with a plurality of printers 1 (1a, 1b, 1c, 1d, 1e, . . . ) via a bus bridge apparatus 2. The server 3 as well as a plurality of personal computers 5 (5a, 5b, . . . ) as client apparatuses is connected with a network such as a LAN 4 according to the Ethernet communication system. The server 3 is constructed so as to be integral with a scanner having a scanner engine and an operation unit. This construction is detailed below. These elements schematically assemble the image processing multifunction system having a LAN system construction. Namely, the system construction includes a combination of the server 3 having one scanner and the printers 1 (1a, 1b, 1c, 1d, 1e, . . . ).

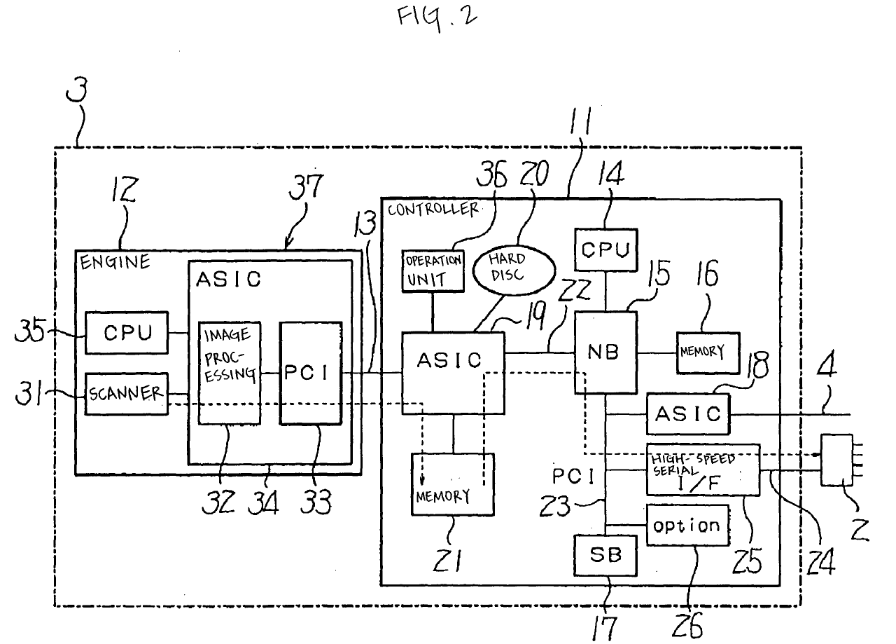

The server 3 having the scanner construction is explained with reference to a block diagram in FIG. 2. The server 3 is constructed so that a controller section 11 and an engine 12 are connected by a peripheral component interface (hereinafter, “PCI”) 13 which is a general-purpose bus. The controller section 11 has a management function which manages and controls the printers 1 (1a, 1b, 1c, 1d, 1e, . . . ) and an image processing function, and fulfills a main function as the server. For this reason, the controller section 11 has a central processing unit (hereinafter, “CPU”) 14 as a main CPU which has charge of the management/control function, a north bridge (hereinafter, “NB”) 15, a system memory 16, a south bridge (hereinafter, “SB”) 17, an application specific integrated circuit (hereinafter, “ASIC”) 18, an ASIC 19 for controller as an integrated circuit for image processing, a hard disc drive (hereinafter, “HDD”) 20, a local memory 21 and the like. The NB 15 is connected with the ASIC 19 for controller by an accelerated graphics port (hereinafter, “AGP”) 22. The NB 15 is connected with the SB 17 by a PCI 23. The PCI 23 is connected with the ASIC 18 connected with the LAN 4, a high-speed serial interface 25 which is connected with the bus bridge apparatus 2 by a high-speed serial bus 24 as a data transmitter based on the high-speed serial interface standards such as the Institute of Electrical and Electronic Engineers (hereinafter, “IEEE”) 1394 and the universal serial bus (hereinafter, “USB”) 2.0 specification, and an option 26 as a free slot which connects the a PCI device and a peripheral device. The high-speed serial interface 25 utilizes one of options as a free slot.

Namely, the NB 15, the system memory 16, the ASIC 18, the high-speed serial interface 25, the option 26 and the SB 17 construct a chip set, and the CPU 14 is connected with another equipment via the chip set.

The NB 15 is used for connecting the CPU 14 with the system memory 16, the SB 17, and the AGP 22. The system memory 16 is used as a drawing memory. The SB 17 is used for connecting the NB 15 with the PCI device and the peripheral device.

The local memory 21 is used as an image buffer for copying, a code buffer and the like. The ASIC 19 is an integrated circuit (IC) for image processing having hardware element for image processing and serves also as a bridge which connects the AGP 22, the PCI 13, the HDD 20 and the local memory 21.

The AGP 22 is a bus interface for graphics accelerator card suggested in order to heighten a graphic process, and accesses directly to the system memory 16 with high throughput, so as to heighten the speed of the graphics accelerator card. The AGP 22 is originally used in order to smoothly display a three-dimensional image on a display, but in this embodiment, the NB 15 is connected with the ASIC 19 via the AGP 22 (in the case of PCI connection, performance is degraded).

On the other hand, the engine 12 includes a scanner engine 31 having monochrome specification, color specification, or facsimile specification, an ASIC 34 for engine, which includes an image processing section 32 which carries out an image process such as error diffusion and y conversion and a PCI section 33, and a CPU 35. Further, an operation unit 36 Which accepts an input operation from a user and carries out displaying for a user in normal copying machine and MFP is connected with the ASIC 19. The engine 12 and the operation unit 36 construct a scanner 37.

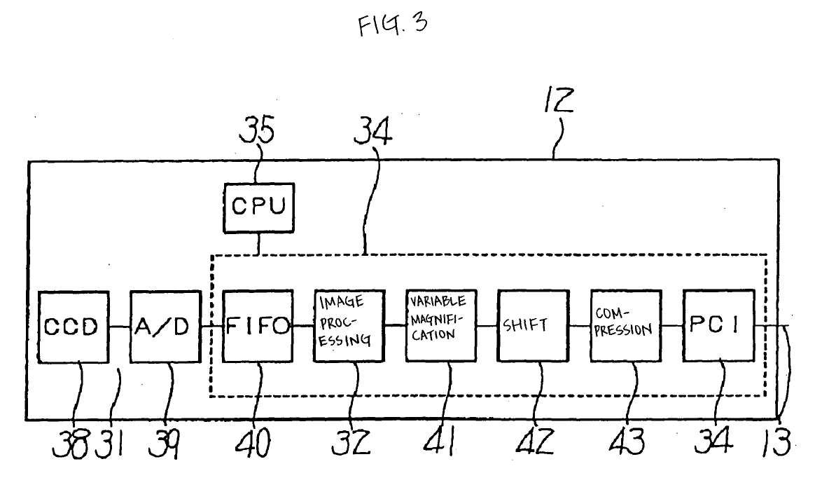

FIG. 3 illustrates the construction of the engine 12 in detail, and the scanner engine 31 includes a charge coupled device (CCD) 38 which receives reflected image light from a document and takes out the light as an electrical signal according to photoelectric conversion, an A/D converter 39 which converts the output into a digital signal so as to gives the digital signal to the image processing section 32, and the like. The ASIC 34 for engine includes a first in first out memory (FIFO memory) 40 which receives the digital signal and adjusts delay, a variable magnification processing section 41 which carries out scaling, a shift processing section 42 which shifts and cuts out an image, and a compressing section (encoder section) 43 which converts multiple value image data into codes. The PCI section 33 includes a portion which executes a bus protocol of PCI and direct memory access controller (DMAC). The PCI section 33 transmits image data to the controller section 1, and transmits a command from the controller section 11 (operation unit 36) to the engine 12.

A construction example of the printers 1 (1a, 1b, 1c, 1d, 1e, . . . ) is explained below. All the printers 1 (1a, 1b, 1c, 1d, 1e, . . . ) may have the same or similar printing ability, but may have different printing performances, namely, their combination may be selected according to object and application of the system. As one example, a combination of the printers 1a and 1b having monochrome high-speed printing specification, the printer 1c having monochrome high-quality printing specification and the printers 1d and 1e having color printing specification can be adopted. It is preferable that a type of the scanner engine 31 complies with a best specification of the printers 1 (1a, 1b, 1c, 1d, 1e, . . . ) (for example, when a color printer is included, a color scanner is adopted).

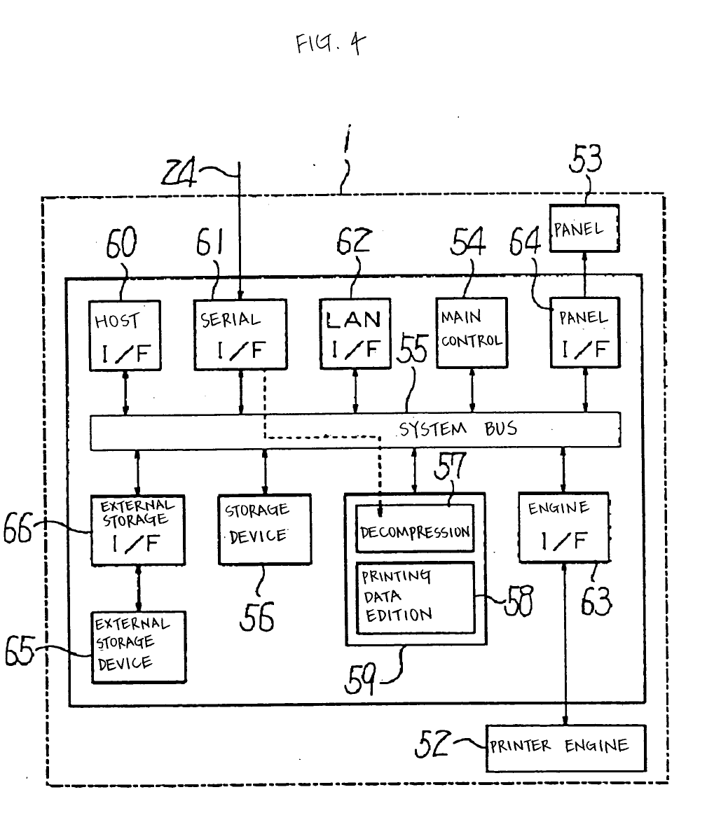

FIG. 4 is a block diagram of an example which is common regardless of differences in the printing ability of the printers 1. The printer 1 includes a controller 51, a printer engine 52 which actually performs the printing operation, and an operation panel 53. A printing system of the printer engine 52 is not particularly limited, but normally a laser printer system or the like is used. The controller 51 has a main control section 54 which has charge of entire control of the printer 1. The main control section 54 is connected with a storage device 56, an image processing section 59, a host interface 60, a high-speed serial interface 61, a LAN interface 62, an engine interface 63, a panel interface 64, and an external storage interface via a system bus 55. The image processing section 59 includes a decompressing section 57 and a printing data editing section 58. The host interface 60 directly connects the personal computer 5 or the like with the main control section 54. The high-speed serial interface 61 connects the bus bridge apparatus 2 with the main control section 54 using the high-speed serial bus 24 as the data transmitter based on the high-speed serial interface standard such as IEEE 1394 and USB 2.0 specification. The LAN interface 62 connects the LAN 4 with the main control section 54. The engine interface 63 connects the printer engine 52 with the main control section 54. The panel interface 64 connects the operation panel 53 with he main control section 54. The external storage interface 66 connects an external storage device 65 with the main control section 54.

In such a construction, an operational control example or the like when the printing operation is performed according to a printing command from an arbitrary personal computer 5 (5a, 5b, . . . ) is explained below. In this case, printing image data are temporarily stored in the local memory 21 from the personal computer 5 (5a, 5b, . . . ) via the LAN 4, the ASIC 18, the north bridge (NB) 15 and the ASIC 19. The printing image data stored in the local memory 21 are output onto the high-speed serial bus 24 via the ASIC 19, the north bridge (NB) 15, and the high-speed serial interface 25. Further, the printing image data are captured into the printer 1 (1a, 1b, . . . ) specified by the personal computer 5 (5a, 5b, . . . ) via the bus bridge apparatus 2, the high-speed serial bus 24, and the high-speed serial interface 61 based on the management function carried out by the server 3. After the captured printing image data are temporarily stored in the storage device 56, the printing image data undergo the decompressing process, the editing process and the like in the image processing section 59, and are output to the printer engine 52 via the engine interface 63. In such a manner, the printing operation is actually performed.

An operational control example or the like when the copying operation is performed is explained below. In this system construction, independent copying machine and MFP are not preset, but when the copying operation is tried to be performed, a document image is read by the scanner 37 in the server 3 so that the copying operation is performed. Namely, in the scanner 37 having the operation unit 36 (server 3), similarly to the case of normal MFP or the like, a copying mode is provided. A document is set for the scanner 37, and a document image is read by the scanner engine 31 according to singular operations such as setting of the copying mode and setting of a number of copies and mode content on the operation unit 36. The read image data undergo necessary image process, compressing process, and the like in the image processing section 32, and are temporarily stored in the local memory 21 via the PCI section 33, the PCI 13, and the ASIC 19. When the reading into the local memory 21 is ended, the controller section 11 issues an output instruction of the image data to the printer 1 (1a, 1b, . . . ) selected based on the management function, and the corresponding printer 1 outputs a reading request to the ASIC 19 according to the instruction. The ASIC 19 reads the image data from the local memory 21 according to the request, and outputs the image data to the high-speed serial bus 24 via the NB 15 and the high-speed serial interface 25. Further the image data are supplied to any of the printers 1 (1a, 1b, . . . ) selected based on the management function of the server 3 via the bus bridge apparatus 2, the high-speed serial bus 24, and the high-speed serial interface 61. The printing image data captured into the printer 1 are temporarily stored in the storage device 56, and undergo the decompressing process, the editing process and the like in the image processing section 59. The image data are, then, output to the printer engine 52 via the engine interface 63, so that the printing operation which is equivalent to the copy printing operation is actually performed.

Namely, the copying function of MFP does not necessarily require scanning/printing which is carried out by the MFP itself unlike independently constructed MFP, and thus it is sufficient that the image data which are read by the scanner being capable of performing the singular reading operation in a separate construction can be output directly on the printer. In this embodiment, a necessary number of printers 1 (1a, 1b, 1c, 1d, 1e, . . . ) are connected with the one scanner 37 which includes the scanner engine 31 and the operation unit 36 and can be performed singularly as an independent machine without depending on the personal computer 5 via the server 3 having the printer management function. As a result, at the time of the copying mode, the document image is simply read by the scanner engine 31 according to the singular operation of the operation unit 36 similarly to the original copying operation, so that the read image data are supplied to any of the printer 1 (1a, 1b, 1c, 1d, 1e, . . . ) via the server 3 so as to be capable of being printed and output. This practically makes it possible to ensure complex machine functions according to the number of the printers. As a result, when the copying function whose frequency in use is low is taken into consideration, the system construction is such that consumption of resources is less and efficiency is high because independently constructed MFP is not provided. When the example of the system construction in offices or the like is considered, for example, a necessary number of the printers 1 which are more inexpensive than MFP are placed on each floor, and one or two serveres 3 (with the scanner 37) are placed according to the extent of floors, thereby obtaining a simple system construction. As a result, the system which can execute necessary processes can be constructed.

Since the server 3 (scanner 37), the bus bridge apparatus 2, and the printer 1 are connected by using the high-speed serial bus 24 based on the high-speed serial interface standards such as IEEE 1394 and USB 2.0 specification, the process at the time of the copying mode can be executed at a high speed, and a resulted copy which is close to one obtained by the copying ability of independently constructed copying machine and MFP can be obtained.

The server 3 having the management function which manages and controls the printer 1 has a function of a printer selecting unit which selects a printer 1 to which the read image data supplied from the scanner 37 are supplied at the time of the copying mode using the scanner 37, and the CPU 14 performs this function.

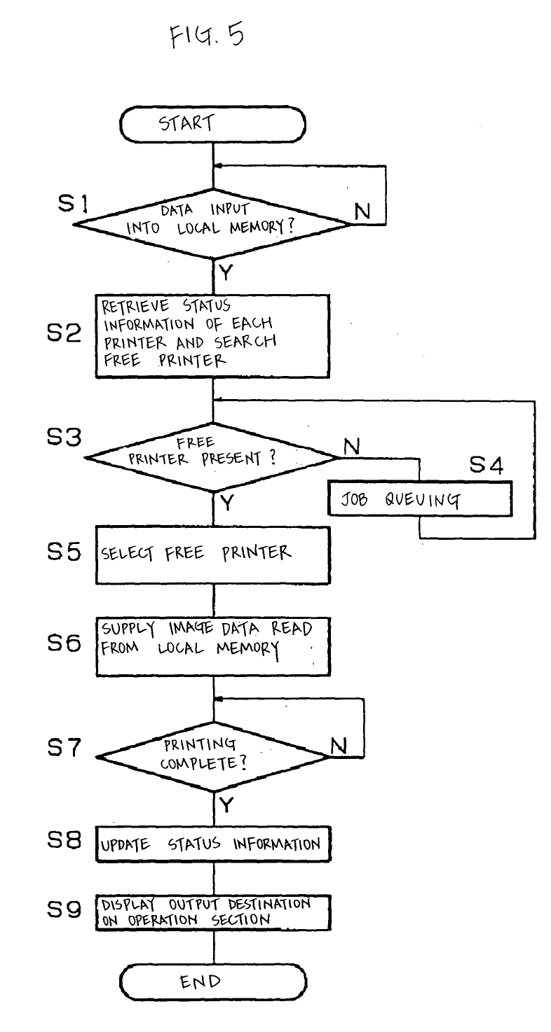

One example of the selecting process executed by the CPU 14 is explained with reference to a schematic flowchart illustrated in FIG. 5. This example is a processing example such that all the printers 1 are constructed by the same or similar kind of printers and thus the printing performances between the printers do not remarkably differ. The copying mode is set in the scanner 37, the CPU 14 waits until the read image data are input from the scanner 37 into the local memory 21 (step S1). When the read image data are stored in the local memory 21 (Y at S1), status information of the printers 1 (1a, 1b, 1c, 1d, 1e, . . . ) connected with the server 3 via the bus bridge apparatus 2 is retrieved so that a free printer is searched (S2). When a free printer is not present (N at S3), a printing job in the copying mode is queued (S4), and the CPU 14 waits until a printer becomes free.

When a free printer is present (Y at S3), the free printer is selected as a printer for copy printing (S5), and the read image data stored in the local memory 21 are supplied to the selected printer (S6), and the copy printing operation is performed by the printer as mentioned above. The steps S3 and S5 are executed as the function of the printer selecting unit. When a post about completion of the copy printing operation is received from the printer (Y at S7), the status information in the server 3 is updated (S8), and a destination as the selected printer to which the resulted copy is output is displayed on the operation unit 36 (S9). The step S9 is executed as a function of a selected printer display unit.

Priority of the printers is previously set (for example, the priority is given to the printers closer to the server 3), and when a plurality of printers are free, a printer may be selected according to the priority.

At the time of the copying mode, therefore, the document image is read simply by the operation unit 36 in the scanner 37, so that the conformed printer is allowed to carry out the copy printing. At this time, since a free printer is selected, a resulted copy can be obtained immediately as long as all the printers are not in use. Further, although the scanner 37 does not have one-to-one correspondence to the printers 1 (1a, . . . ), the printer selected at the copying mode is displayed on the operation unit 36 of the scanner 37 which takes a document, so that the printer from which a resulted copy is obtained can be manifested to a user.

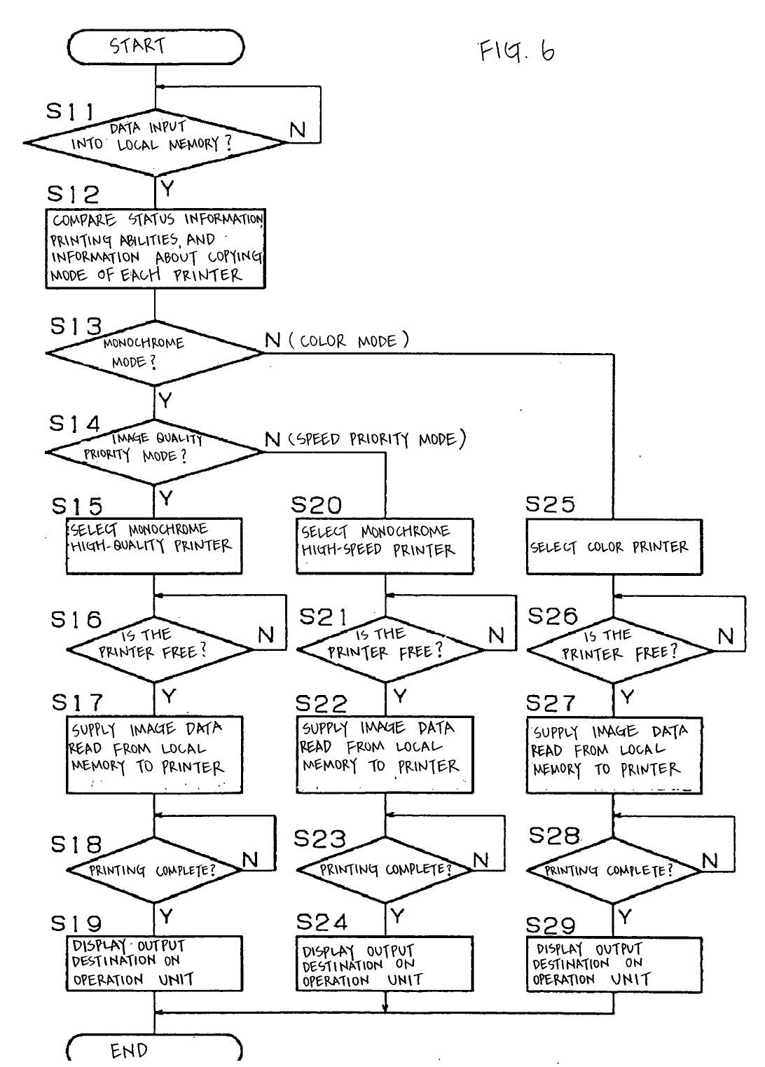

Another example of the selecting process executed by the CPU 14 is explained with reference to a schematic flowchart illustrated in FIG. 6. This example is a processing example in which the printers 1a and 1b have the monochrome high-speed printing specification, the printer 1c has the monochrome high-quality printing specification, and the printers 1d and 1e have the color printing specification, and thus the printing performances are different. Further, the scanner 37 is a color scanner.

The copying mode is set in the scanner 37. In the copying mode, a monochrome/color mode, an image quality priority mode, a speed priority mode, and the like are set, the reading operation is performed, and the CPU 14 waits until the read image data are input from the scanner 37 into the local memory 21 (step S11). When the read image data are stored into the local memory 21 (Y at S11), the status information about the printers 1 (1a, 1b, 1c, 1d, 1e, . . . ) connected with the server 3 via the bus bridge apparatus 2, the printing performances, and information about the contents of the copying mode set in the operation unit 36 are obtained so as to be contrasted (S12). As a result, when the monochrome mode is set (Y at S13), a determination is further made whether the image quality priority mode (Y at S14) or the speed priority mode (N at S14) is set. When the monochrome mode and the image quality priority mode are set (Y at S13 and Y at S14), the printer 1c having the monochrome high-quality printing specification is selected (S15), and a determination is made based on the status information whether the printer 1c is free (S16). When the printer 1c is not free (N at S16), the sequence waits until it is free. The read image data stored in the local memory 21 are supplied to the selected printer 1c (S17), and the copy printing operation in the monochrome high-quality mode is performed by the printer. Thereafter, when a post of completion of the copy printing operation is received from the printer 1 (Y at S18), the destination as the selected printer to which the resulted copy is output is displayed on the operation unit 36 (S19).

On the other hand, when the monochrome mode and the speed priority mode are set (Y at S13 and N at S14), the printer 1a (or 1b) having the monochrome high-speed printing specification is selected (S20), and a determination is made based on the status information whether the printer 1a (or 1b) is free. When the printer is not free (N at S21), the sequence waits until it is free. The read image data stored in the local memory 21 are supplied to the selected printer 1a (or 1b) (S22), so that the copy printing operation in the monochrome high-speed mode is performed by the printer. Thereafter, when a post of completion of the copy printing operation is received from the printer 1a (or 1b) (Y at S23), the destination as the selected printer to which the resulted copy is output is displayed on the operation unit 36 (S24).

When the color mode is set (N at S13), the printer 1d (or 1e) having the color printing specification is selected (S25), and a determination is made based on the status information whether the printer 1d (or 1e) is free (S26). When the printer 1d (or 1e) is not free (N at S26), the sequence waits until it is free. The read image data stored in the local memory 21 are supplied to the selected printer 1d (or 1e) (S27), so that the printer is allowed to execute the copy printing operation. Thereafter, when a post of completion of the copy printing operation is received from the printer 11 (or 5e) (at S28), the destination as the selected printer to which the resulted copy is output is displayed on the operation unit 36 (S29).

In these operations, the steps S13, S14, S15, S20, and S25 are executed as the function of the printer selecting unit, and the steps S19, S24, and S29 are executed as the function of the selected printer display unit.

The printers 1 have at least one of a difference in image quality, a difference in printing speed, and a difference between color printing and monochrome printing as the different printing performances, so as to be diversified according to applications and objects. As a result, a high-quality resulted copy, the copying operation at high copying speed, a resulted color copy, and the like, for example, can be obtained, thereby increasing alternatives of the printers. As the operational control in this case, a desired resulted copy can be obtained from the printer conformed to the mode set by the operation unit 36, so that resulted copies which comply with objects and applications can be obtained easily.

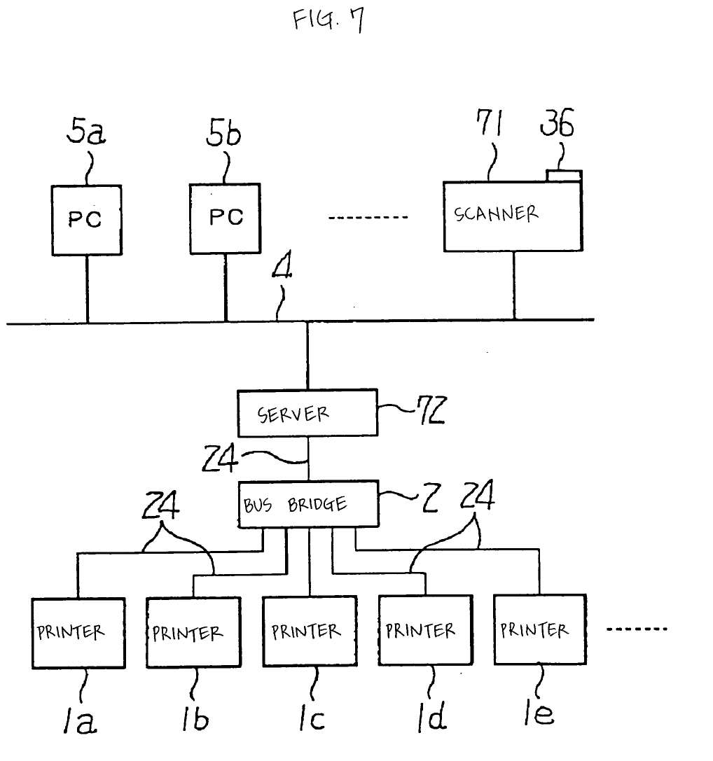

In this embodiment, the scanner 37 is constituted so as to be integral with the server 3, thereby simplifying the system construction. As shown in FIG. 7, however, a scanner 71 may be provided separately from a server 72, and they may be connected via the LAN 4. The server 72 in this case is constituted mainly by the controller section 11, but the operation unit 36 as well as the engine 12 is included in a scanner 71. The scanner 71 is also connected with the server 72 via the LAN 4 and the ASIC 18 similarly to the personal computer 5 or the like. According to such a construction, when the image processing multifunction system having a plurality of printers 1 is constructed, the scanner 71 which can be operated singularly is connected with the server 72, which is connected with the LAN 4, via the LAN 4, thereby making the scanner 71 to serve as a printing information providing unit similar to the personal computer 5. As a result, the printing information from various providing units can be printed and output by the printer 1.

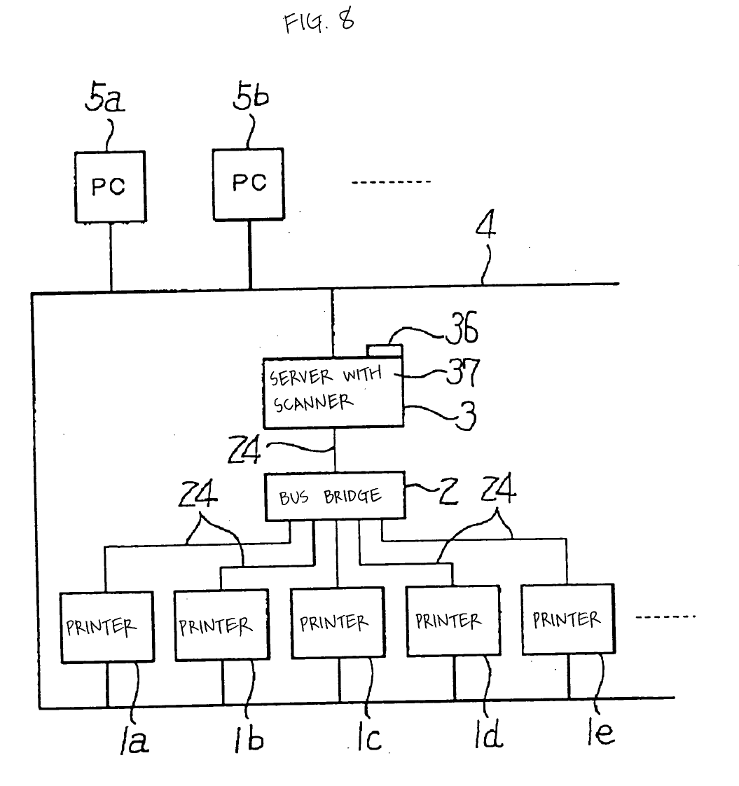

When the system shown in FIG. 1 is constructed, in order that each personal computer 5 directly gives the printing instruction to each printer 1, transmit data thereto and the like without involving the server 3, as shown in FIG. 8, each printer 1 may be connected also with the LAN 4 by using the LAN interface 62.

In the image processing multifunction system according to one aspect of the present invention, a document is read by the scanner of the operating unit and the read image is printed by a printer connected to a server.

The scanner can be provided as the printing information providing unit similarly to the personal computer, and the printing information from various providing unit can be printed and output by the printer.

The present invention can be realized on the system construction utilizing the most general-purpose network.

The present invention can be realized on the printing system which secures the printing function which allows the printer to print and output data according to an instruction from a client apparatus.

The system construction can be simplified.

A printer can be selected out of a plurality of printers connected with the server.

When a plurality of printers is connected via the bus bridge apparatus, the printers can be connected easily by using HUB similarly to the local area network.

When a copy is obtained by using the scanner, the copying operation and a resulted copy can be obtained according to applications and objects.

Diversifications such as obtaining of a high-quality resulted copy, a copying operation at high speed, a resulted color copy, and the like are enabled according to applications and objects, thereby increasing alternatives of printers.

The copy can be printed by a conformed printer.

A desired resulted copy can be obtained from the printer conformed to the mode set by the operation unit, and particularly when a plurality of printers have different kinds of printing performances, a resulted copy which conforms to objects and applications can be obtained.

A resulted copy can be obtained immediately from a free printer as long as all the printers are not in use.

The scanners do not have one to one correspondence to the printers, but the printer selected at the copying mode is displayed on the operation unit of the scanner which handles a document, thereby manifesting the printer which obtains a resulted copy to a user.

The present document incorporates by reference the entire contents of Japanese priority document, 2002-265812 filed in Japan Sep. 11, 2002.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An image processing multifunction system comprising:
a plurality of printers, a plurality of scanners, and a server connected to each other, wherein
each of the scanners acquires image data of a document and the server sends the image data acquired by the scanner to one of the printers for printing.

2. The image processing multifunction system according to claim 1, wherein each of the scanners includes an operation unit having a configuration such that the scanner can be operated by operating the operation unit alone.

3. The image processing multifunction system according to claim 1, wherein the number of the scanners is less than the number of the printers.

4. The image processing multifunction system according to claim 1, wherein the scanners and the server are connected via a network.

5. The image processing multifunction system according to claim 4, wherein the network is a local area network based an Ethernet communication system.

6. The image processing multifunction system according to claim 4, further comprising a client that is connected to the network.

7. The image processing multifunction system according to claim 1, wherein the scanners are integrated in the server.

8. The image processing multifunction system according to claim 1, wherein the server and the printers are connected via a bus bridge.

9. The image processing multifunction system according to claim 8, further comprising:
a data transmitting unit conforming a high-speed serial interface standard, wherein the data transmitting unit connects the server with the bus bridge, and the bus bridge with the printers.

10. The image processing multifunction system according to claim 1, wherein the printers have different printing performances.

11. The image processing multifunction system according to claim 10, wherein the different printing performances include at least one of a difference in image quality, a difference in printing speed, and a difference between color printing and monochrome printing.

12. The image processing multifunction system according to claim 1, wherein the server includes
a printer selecting unit that selects a printer to which the image data are to be supplied.

13. The image processing multifunction system according to claim 12, wherein the printer selecting unit selects a printer that complies with a mode set by the operation unit of the scanner.

14. The image processing multifunction system according to claim 12, wherein the printer selecting unit selects a printer that is free.

15. The image processing multifunction system according to claim 12, wherein the server further includes
a display controller that makes the operation unit of the scanner display the printer selected by the printer selecting unit.

16. A server comprising:
a first interface to which a plurality of printers and a plurality of scanners are connected, wherein each of the scanners acquires image data of a document; and
a second interface to which a network is connected, wherein
the server sends the image data acquired by the scanner to one of the printers for printing.

17. The image processing multifunction system according to claim 16, wherein each of the scanners includes an operation unit having a configuration such that the scanner can be operated by operating the operation unit alone.

18. The server according to claim 16, wherein the scanners are integrated in the server.

19. A scanner comprising:
an interface that is connected to a server, wherein the server is connected with a network and a plurality of printers, manages and controls the printers;
a scanner engine; and
an operation unit, wherein
when in a copying mode, the scanner reads image data from a document via the scanner engine by operating the operation unit alone, and supplies the image data to one of the printers via the server.
